(19) United States
(12) Patent Application Publication
(10) Pub. No.: US 2013/0005867 A1
(43) Pub. Date: Jan. 3, 2013

(54) ADHESIVE ADDITIVE

(75) Inventor: Daniel F. Varnell, Wilmington, DE (US)

(73) Assignee: HERCULES INCORPORATED, Wilmington, DE (US)

(21) Appl. No.: 13/537,372

(22) Filed: Jun. 29, 2012

Related U.S. Application Data
(60) Provisional application No. 61/503,067, filed on Jun. 30, 2011.

(51) Int. Cl. C09J 139/06; C09J 197/02; C08K 11/00

(52) U.S. Cl. 524/14; 525/154; 525/55; 524/17; 524/502; 524/9

(57) ABSTRACT

A lignocellulosic-based composite composition comprising an adhesive and a water soluble polymer that increases the tack of the composition.

This application claims the benefit of U.S. provisional application No. 61/503,067 filed Jun. 30, 2011, the entire contents of which are hereby incorporated by reference.

### FIELD OF THE INVENTION

The invention is directed to compositions of adhesives used in preparation of lignocellulosic based composites, where the adhesive composition comprises an adhesive and water and a tack additive which is a water soluble polymer. The water soluble polymers provide tack properties, that is they impart improved tack to the composite formulation when the composite is formed into a structure, but prior to setting of or extensive cure of the adhesive in the composite structure. The invention is also directed toward the process of using such adhesive compositions in preparation of lignocellulosic based composites wherein the tack additives, water soluble polymers, in the adhesive compositions provide improved tack during the preparation of the final form of the composites.

### BACKGROUND OF THE INVENTION

Lignocellulosic-based composites, such as particle board, are prepared from combinations of a lignocellulosic such as wood, and a binder, also known as a resin and also known as an adhesive. Therefore, a lignocellulosic composite comprises a lignocellulosic material held together by an adhesive. In most composite manufacturing processes that utilize an adhesive, the adhesive portion sets up. That is the adhesive portion goes from being a liquid to a solid. The adhesive may set up by loss of water into the air or into another portion of the composite, or by a phase change, or by a chemical or physio-chemical change of the adhesive. Most composites are shaped prior to the setting up of the adhesive. In operations, such as the manufacturing of particle board, layers of treated biomaterial, such as wood chips, are formed, then cold pressed to form an uncured mat, and then hot-pressed to set-up the adhesive. For such cases the molded form is a large plainer sheet. For other applications the shape might be more complex, such as that of a flower pot. In some processes, the shaped part must have some integrity even before the adhesive has set-up. This structural integrity may be referred to as green strength or cohesive strength or tack. Tack is the term typically used at a particle board manufacturing site. Tack could also refer to the impartation of such cohesive strength by the adhesive portion of the composite. In the formation of something like a composite structure in the shape of a bowl the need for tack would be required if the bowl were free standing during the process when the adhesive has yet to set. Tack is also required even of materials formed into sheets. For example, on some particle board manufacturing lines the formed mat is divided into sheets of the size of a final board product in the planer directions and then the sheets travel to a heated press. As the boards travel to the press they may span a gap and be unsupported for a time (a line without a cull). In this and other operations the uncured shaped composite structure requires some cohesive strength for the shape of the uncured composite to be maintained and to be void of cracks or fissures or other defects that might occur because of a lack of tack. Often an adhesive, for the composites, is said to have bad or good tack properties. For many applications the lignocellulosic provides no tack and does not retain a structure as an uncured material in the absence of an adhesive.

Many adhesives in the composite industry, especially where biomaterials are used, are water-borne. That is water serves as a primary component either to dissolve or disperse the adhesive components. For example urea-formaldehyde (UF) adhesives are often provided in the form of a dispersion in water. Most latex adhesives are emulsions or dispersions based on water. Historical and more recent protein based adhesives are water based. Various water based adhesives are described in numerous books, articles, and patents. See for example patents describing soy flour based adhesives (such as U.S. Pat. Nos. 7,060,798 and 7,252,735), urea formaldehyde (UF) based adhesives, melamine urea formaldehyde (MUF) adhesives, melamine formaldehyde (MF) adhesives, phenol formaldehyde (PF) adhesives, and poly(vinyl acetate) and poly(ethylene vinyl acetate) adhesives.

It is recognized in the composite industry that some adhesives provide good tack and others do not. The effect of the composition of UF adhesives on tack is discussed in an article by Leichti, Hse, and Tang, “J. Adh, 1988, pp 31-44. UF resins are generally considered to have good tack. Although UF resins are very strong, fast curing, and reasonably easy to use, these resins lack hydrolytic stability along the polymer backbone. This causes significant amounts of free formaldehyde to be released from the finished products (and ultimately, inhaled by the occupants within the home). There have been several legislative actions to push for the removal of these resins from interior home applications (Health and Safety Code Title 17 California Code of Regulations Sec. 93120-93120.12). For this reason there is interest in the MF adhesives and formaldehyde free adhesives, such as the ones based on soy flour. Generally, these later materials do not have the same level of tack as UF resins and would benefit significantly by the current invention.

Some adhesives, such as methylene bisphenol diisocyante (MDI) are also known to have very poor tack. Although MDI is supplied as a 100% active product with no water and is not water soluble, water is generally added during use, such in the making of particleboard. Therefore, as an adhesive it can benefit from the water soluble polymer tack additives of the current invention.

Tackifiers for non-water based adhesives are well known. Typically materials such as rosin esters are used. One general mechanism is to modify the glass transition temperature of the adhesive and another is to modify the rheology. Like the adhesive, the tackifiers are not water soluble. Modifications to latex adhesives to improve tack are also known. Generally they also involve modifying the glass transition temperature of the water insoluble polymer that is the dispersed phase of the latex. The modification is made by adding another monomer into the polymer backbone or by adding a plasticizer that is miscible with the polymer. The plasticizers are not water soluble or they would be extracted from the polymer by the water phase of the latex. Even in a water based urethane adhesive where the urethane portion is dispersed, as described in U.S. Pat. No. 5,688,356, the tackifiers described, such as Tacolyn 1085, is a rosin ester that is not water soluble.

Tackifiers are known in the plywood industry. The tack between layers of veneer is important during manufacturing. US Patent application US20050257888A1 has as an option the addition of a tackifier to a plywood adhesive where the adhesive is based on water-based phenol formaldehyde resin. The tackifiers mentioned are soya compounds which are added neat to the adhesive to increase viscosity. The soya compounds discussed have 50-75% protein content and are recognized as soy bean flour and soy bean concentrate. They are not fully water soluble. The patent mentioned another tackifier for plywood, which is Borax. It is not a polymer.

Tack and tackifiers play an important role in pressure sensitive adhesives. U.S. Pat. No. 5,395,907 describes water-based pressure sensitive adhesives based on water soluble or water dispersable polymers that comprise one or two types of monomers and a water soluble macromer. The composition can be adjusted to provide tack. The macromer portion can be among other things polyacrylic acid, polyvinylalcohol, or polyvinylpyrrolidone. The application differs from the current invention in that a pressure sensitive, not cured adhesive is involved. The composition is different because the entire adhesive is based on a water soluble or water dispersible co- or ter-polymer of which water soluble polymers are reacted in as macromers.

There remains the need for additives that enhance the tack in biobased composites formed with water based adhesives, especially water based adhesives that emit little or no formaldehyde.

Composite adhesives have certain viscosity restrictions which depend on the process they are used in. For example in the manufacturing of particle board the adhesive is sprayed onto and then mixed with the biomaterial (typically wood). The adhesive formulation must therefore be sprayable. An additive to enhance tack provided by an adhesive must not interfere significantly with the process used to make the composite thus rendering the adhesive unusable or its use impractical.

Adhesives for water-based composite also have limitations on the solids that can be used. Too much water added to the composite by the adhesive can prevent the successful manufacturing of the composite. There could be too much shrinkage, or if curing by hot-pressing, too much steam pressure may build inside the formed structure. The pressure can lead to delaminating of the structure or blowing apart of the structure when pressure is released. This is a common problem in the manufacturing of particle board.

Additives to enhance tack must not substantially detract from the performance properties provided by the adhesive.

### BRIEF SUMMARY OF THE INVENTION

The current invention improves tack provided by uncured adhesives. The current invention pertains to the addition of low levels of certain water soluble polymers to water based adhesives for the enhancement of the tack the adhesives impart to the formed, but not cured or set, composite structures. The current invention helps maintain a formed shape of a composite until curing of the adhesive can be carried out.

Tack is a term defined in composite technology for the ability of the composite to hold together prior to curing. Tack it is also called green strength or cohesive strength.

The invention is directed to final adhesive compositions used in the preparation of bio-based composite materials such as particle board. The tack additives of this invention are water soluble. In addition water solutions of the tack additives may be prepared and such water solutions if made at 10% solids will have a viscosity below 50,000 cps, at 22° C. Similarly, solutions at 5% solids, at 22° C., will have a viscosity above 25 cps. Alternatively, the solution of the tack additives may contain a salt or polar water soluble compound, like urea, to break-up inter and intra polymer chain hydrogen bonding and in this way obtain a liquid solution of the same viscosity limitations. The amount of the salt being less than 50% by weight and the amount of the polar water soluble compound being less than 100% of the tack additive. Furthermore solutions of the tack additives if cast into films at room temperature will form continuous films when dried. The tack additives have number average molecular weights of greater than 8000 g/mole. Also critical for tack are the properties of the tack additives at the moisture contents of the adhesive after it is applied to the primary component of the composite. For example, if the adhesive is applied to wood at room temperature and the moisture content of the adhesive in the presence of the wood is on average 30%, then the glass transition temperature (Tg) of the tack additive in its pure form and at a 30% moisture content must be below room temperature. In addition the Tg of the uncured adhesive mixture, or the continuous phase of the adhesive mixture, must be below room temperature.

The invention is also directed to the use of the above compositions in the process of preparing shaped bio-based structures (even if said structure is just a flat rectangle that will be made into a board). For example, the process for making particle board on a line with no cull is enhanced by an increase of the tack by improving the board integrity and thus preventing cracks and fissures.

### DETAILS OF THE INVENTION

A composition comprising an adhesive and a tack additive is disclosed, wherein the tack additive is a water soluble polymer with a number average molecular weight greater than 8000 g/mole and a viscosity at 5% solids in water of less than 10,000 cps and greater than 20 cps and a viscosity at 10% solids of less than 50,000 cps and greater than 30 cps at 22° C.

The present invention also discloses a composite made from the composition of the present invention.

### Adhesives

In the composites the primary materials are held together or bonded together or glued together by an adhesive. For many lignocellulosic composites the most common adhesives are urea-formaldehyde resins and phenol formaldehyde resins. The current invention is applicable to adhesives that are soluble in or that can be diluted with water. That is, water is present as a major component during their use. These are sometimes called water-based adhesives. Examples of suitable adhesives include but are not limited to the UF, MF, MUF, PF adhesives as well as polyvinyl acetate dispersions, poly(ethylene vinylacetate) dispersions, vegetable glues, glues of animal origin, polyamides, polyamidoamine-epichlorohydrin resins, protein based glues (including soy flour based glues), gelatins based glues, and various combinations of them. Even adhesives such as isocyanates are often used with the addition of a significant amount of water. Examples of isycyantes used with water include but are not limited to hexamethylene diisocyante and methylene bisphenyl isocyante.

In one embodiment of this invention the adhesive contains no added formaldehyde.

In one embodiment of this invention the adhesive is based predominantly on a natural product, for example protein or lignin, thus complimenting the use of a lignocellulosic as the primary material. The adhesive can be based on a protein source where the source is at least 40% by weight protein. Protein based adhesives are useful in the present invention.

The adhesive can be a mixture of a protein source and a crosslinker. Polyamidoamine-epichlorohydrin resins, polyamine-epichlorohydrin resins, an isocyante, an epoxy, and aldehyde, an aldehyde starch, and mixtures thereof can be used as a crosslinker.

Suitable sources of protein include, but are not limited to, soy protein, blood meal, feather meal, keratin, gelatin, collagen, gluten, spirulina, casein, soy flour, wheat gluten, corn gluten, peanut flour, lupin flour, and egg whites. The protein may be pretreated or modified to improve its solubility, dispersability and/or reactivity. Soy flour, soy concentrate and soy isolates can be used as the source of protein for the adhesive. One particularly useful source of protein for the current invention is soy flour (about 50 wt. % protein, dry basis. The present invention applies to aqueous soy/PAE adhesives regardless of the Protein Dispersibility Index (PDI) of the soy flour used. The PDI is a means of comparing the solubility of a protein in water, and is widely used in the soybean product industry. The Lignin may be an industrial lignin such as Kraft lignin, obtained from the Kraft process of making cellulose pulp from wood.

Some examples of adhesive compositions of the present invention can be prepared by combining a polyamidoamine-epichlorohydrin (PAE) type resin with a protein and/or lignin.

Other additives may be included in an adhesive formulation such as extenders, viscosity modifiers, defoamers, diluents, catalysts, formaldehyde scavengers, biocides, and fillers.

The components of the adhesive formulation are generally combined in a suitable mixer and are stirred until a homogeneous mixture is obtained, but components may also be mixed in an application line, by co-spraying, or even in situ in the composite structure. The tack additives may be predissolved in water and then mixed with the adhesive formulation or they may be dissolved into some other portion of the adhesive or the entire adhesive formulation. The tack additive may also be applied separately to the primary material of the composite. Preferentially the tack additive of the current invention is mixed with at least one part of the adhesive formulation prior to being applied to the primary material of the composite.

For the current invention the adhesive compositions may be prepared with any solids. However, the solids requirements of the final composites limit the feasability of using very low adhesive solids. The ability to apply the adhesive often leads to an upper limit of solids because viscosity generally increases as the solids increases. Preferably the solids of the adhesive compositions of the current invention will be above 25% and more preferably above 40% and most preferable above 50% by weight.

The preferred content of the tack additives of the present invention is below 25% of the adhesive, on a solids basis, preferably below 20%, and more preferably below 15%, and most preferably below 5%.

In one embodiment of this invention a high molecular weight polyvinylpyrrolidone was found to be effective below 2% content of the adhesive.

The polymer tack additives of the current invention can operate at any adhesive pH range, provided the solubility and rheology requirements of the tack additives noted below are maintained and the tack additive is stable for the time needed to mix and apply the adhesive in a particular application. The polymer tack additives need not be thermally stable under the cure conditions of the composite because they will have fulfilled the reason for which they were added.

The current invention is also directed toward a method of improving the tack of lignocellulosic composites prior to setting up or curing of the adhesive, wherein the adhesive of the composite is water based. Tack is improved by adding a tack additive to the adhesive composition used in forming a composite. The method comprises adding a tack additive to the adhesive composition or a component of the adhesive composition, combining a lignocellulosic with the adhesive components and forming the combination of lignocellulosic and adhesive into a shape. The final composite structure is formed by setting or curing the adhesive. The tack is that ability of the unset and uncured but formed or shaped composite to hold its shape and remain cohesive from the time the composite is formed or shaped to the time it is set-up or cured or hardened. For this invention, setting-up means the process by which the adhesive goes from a liquid to a solid and generally is the point where substantial strength is developed (more than tack) in the formed structure. The adhesive may set-up by different means such as loss of water or by a curing mechanism, such as a chemical reaction. Tack can also be considered the strength of the unset or uncured or unhardened composite.

The tack additives of the current invention (the tack additives) are water soluble polymers (including alkaline and acidic solutions). The tack additive polymers must be such that they can be made into a water solution. Heat may be used and even necessary to obtain a uniform solution. Solutions of the polymer tack additives must be such that at a concentration of 5%, by weight, the viscosity is less than 10,000 cps and greater than 20 cps, with viscosity being measured by RV Brookfield Viscometer on samples effectively stirred for at least 30 seconds prior to the measurement at a temperature of 22° C. More preferably the same viscosity will be below 5,000 cps and above 25 cps. The stirring is meant to breakdown the thixotropic increase of viscosity of some polymer solutions. The viscosity at 5% solids, by weight, is a limit based on the ability to use the polymer tack additive in a formulation without substantially diluting it and it is related to the mechanism of tack formation because it provides an indication of the rheological behavior of the polymer used as the tack additive. Without wishing to be bound by theory, tack is related to the yield strength of the adhesive at the conditions in the composite. It has been noted that materials that are more soluble retain their tack in use. At the same time the tack imparted by a polymer increases with molecular weight. The polymer tack additives of this invention are water soluble. Aqueous solutions of the tack additives may be prepared with a concentration of 10% by weight. The 10% solutions must have a viscosity below 50,000 cps and preferably at the same time have a viscosity above 30 cps at a temperature of 22° C. Alternatively, the polymer solutions (5 and 10%) may contain a salt or polar water soluble compound, like urea, urea derivatives or other amine compounds, to break up inter and intra polymer chain hydrogen bonding. The amount of salt by weight being less than 50% and the amount of polar water soluble (hydrogen bond breaking) component being less than 100% the level of polymer. Examples of useful salts are alkali and alkaline earth salts metal salts, sodium, potassium, magnesium, calcium salts all are useful in the present invention, preferred is sodium chloride. Inorganic salts are useful in the invention. Furthermore the polymer solutions if cast into films at a temperature between 22° C. and 50° C. will form continuous films when dried. That is they are film-formers. Furthermore, they have number average molecular weights of greater than 8000 g/mole and preferable greater than 12,000 g/mole and most preferably greater than 30,000. The higher the molecular weight while satisfying the other characteristics, the better the tack imparted by the adhesive, Furthermore, the glass transition temperature of the polymer tack additives used in the current compositions, at 30% moisture content or above, must be below the temperature at which tack is needed, typically the temperature is in the range of from about 22 to 55 C, however the exact temperature depends on the composite processing conditions

In one embodiment the tack additive has a molecular weight greater than 100,000 g/mole, preferably greater than 500,000 g/mole.

The tack additive can be a carboxymethylcellulose polymer, a polymer formed at least in part from acrylamide, or a polymer formed at least in part from vinylpyrrolidone. The tack additive can be a biopolymer. Examples of tack additives include but are not limited to polyvinylpyrrolidone, polycarboxymethylcellulose, polyacrylamide, polyvinylalcohol (with enough polyvinylaceate present to be water soluble), polyvinylacetate, polyamines, poly(ethylene glycol), polyacrylic acid, and mixtures and copolymers of these. Others are polyhydroxypropyl cellulose and other cellulosic ethers of appropriate molecular weight and solubility.

In one embodiment of this invention a preferred tack additive is polyvinylpyrrolidone. The preferred molecular weight of a polyvinylpyrrolidone is greater than 1,000,000 g/mole and the most preferred is greater than 2,000,000 g/mole.

Another preferred tack additive is a copolymer of acrylamide and acrylic acid, such as Hercobond® 2000 (Ashland Inc. or its subsidiaries, Covington Ky.). Still another preferred polymer is carboxymethylcellulose degraded to a molecular weight less than 20,000. such as Ambergum™ 1221 (Ashland Inc. or its subsidiaries, Covington Ky.).

Composites are composed of multiple materials, typically a primary material, such as wood or a type of fiber or type of filler that is held together by an adhesive. An adhesive used for composites may also be referred to as a binder or resin. The primary material comprises the major part of the composite in a range from 40 to 99% by volume and preferably in the range of 60 to 99% by volume and most preferably from 70 to 98% by volume. The adhesive portion comprises from 1 to 60% of the composite by volume and preferably from 1 to 40% and most preferably from 2 to 30%, and most preferably from 3 to 15%.

For the current invention the composite primary material is a lignocellulosic. The most common lignocellulosic is wood. The lignocellulosic primary materials may come in various forms and shapes. Examples of lignocellulosics in fiber form include but are not limited to: wood fibers; plant fibers, such as derived from bamboo, soy bean plants, sugar cane; cellulose fibers such as pulp as used in paper. Carbonized forms of these can be used. Some common lignocellulosics in the form of powders include, but are not limited, to soy bean hulls, nut shells, bamboo powder, and wood dust.

In one embodiment of the invention the primary material of the composite is wood, preferentially wood dust and particles and chips such as used in making particle board.

In one embodiment of the invention the composite structure is particle board.

The primary material in the form of fibers can be such that the fibers can be used as loose material or in other forms such as non-woven sheets. Fillers are generally used in a ground form. The fiber or fillers used as the primary material of the composites of the current invention are predominantly water insoluble.

The moisture content of the composite structures when being formed, pressed and cured (if it is cured) is important to processing and tack. For particle board applications the moisture content limits are discussed in Modern Particleboard & Dry-Process Fiberboard Manufacturing by Thomas M. Maloney. It is impractical to state all typical process ranges for preparation of various composite structures, but they are well known or can be easily found by those familiar with each manufacturing process.

To obtain good composite properties the adhesive should be applied uniformly to the primary material and also be well distributed and evenly distributed throughout the primary material. Those skilled in the art will be familiar with the means for obtaining proper mixing of the adhesive and primary material. For example in the manufacturing of particle board it is common for the adhesive to be sprayed onto moving wood particles which are then further tumbled or mixed.

### Structures

The present invention applies to composite structures comprised of the primary materials described above and held together by an adhesive. The composite can vary in the level of primary and adhesives materials as described above. For the current invention, the composite is formed into a structure. The composite structures can take many forms from functional shapes, such as bowls, to large sheets such as used to make board products. The structures can be formed from, but are not limited to, loose particles treated with adhesive or sheets of fibers treated with adhesive. The structures can be formed prior to or after combining the adhesive and the primary material. The compositions of the structures can contain other materials such as waxes, dyes, catalysts, catalysts for the curing of the adhesive, other fillers, flame retardants, biocides, and other additives known in the composite industry. The adhesives may also contain these materials in either soluble or dispersed form and the additives may be premixed with the adhesive or added at the same time as the adhesive. The adhesive may also contain diluents, some diluents may alter cure properties, while others may act as plasticizers, and others may be present to increase the solids of the composition, and others may altar the rheology properties. The composite and adhesive compositions may also contain a scavenger for formaldehyde. One such example is urea and another is dimethylurea.

A preferred structure of the current invention are sheets used in the preparation of particle board. Various methods are used to form and press such sheets.

### EXAMPLES

Tack may be measured in different ways. For the purpose of the current invention it is measured, and thus defined. by forming a composite structure and testing its integrity. A 3″ by 10″ by ¼″ rectangular structure (sheet) is formed. The structure is made by combining the primary material of a composite (such as wood particles) with an adhesive and then a certain weight of the uncured composite/adhesive mixture is measured out and placed in a 3″×10″ (inner dimension) frame at a uniform thickness and then while still in the frame the uncured material is pressed with 6000 pounds of pressure (200 psi) to form a formed structure. Then the frame is removed without disturbing the formed structure. The formed structure is made with a metal platen below it and between the platen and the structure is a thin pliable plastic sheet. The platen allows the formed uncured composite to be moved without influencing the tack results. After pressing the platen, plastic, and structure are moved to a table. The edge of the platen is aligned with the edge of the table. The part, riding on the plastic, is then slowly pulled over the edge of the table with the longest length of the structure perpendicular to the edge of the table. The pull over the edge of the table is done at a steady rate of about 1 cm/sec. The structure is moved by pulling the plastic sheet below it over the edge and downward from the top of the table. As each structures extends off the edge of the table it reaches a point at which it cannot support its own weight. The end off the end of the table will break off and fall. The distance a sample extends off the end of the table before breaking off is taken as a measure of tack. The longer a sample extends over the edge the higher the tack, that is, the more integrity it has. Samples are compared to get a relative effect of the compositions of this invention on tack. Samples were compared to control sample(s) prepared at the same time under the same conditions.

The tack test must be adapted slightly for different types of samples which may vary in ways such as adhesive content, composition, sample thickness, pressure used to form, moisture content, and rate of pull off the table.

### Example 1a

An adhesive consisting of a mixture of a Urea/Formaldehyde resin, of the type designed for use in particle board, and urea in the form of a water solution was prepared with a ratio of 100 to 12, on a solids weight basis. It was used immediately. The final adhesive had a solids content of 55.1% by weight. It was used to treat wood particles which were made into a sample of particleboard. The wood particles were those typically used in the preparation of the face of a commercial particle board. The adhesive treatment level was 5.5 parts by weight on a dry basis to 100 parts wood on a dry basis, that is 94.8% wood and 5.2% adhesive. The moisture content of the adhesive treated wood at the time of pressing was 7% by weight. The wood was treated by spraying the adhesive onto it as it was being rapidly tumbled in an 800 Watt Bosch Universal PLUS Mixer, model MUM6N11, fitted with the manufacturers cookie dough paddles. 591 g of the adhesive treated wood was formed into a uniform layer 3″ by 10″ to simulate a large sheet structure, as used in the commercial production of particle board. The 3″ by 10″ layer, while held by a form, was pressed, at room temperature, with 200 psi pressure and held at the pressure for 15 seconds. On release of the pressure the form maintaining the x/y planer dimensions was removed. The tack of the pressed structure was measured by the method described above. Several samples were tested. The average tack was 8.17 cm.

### Example 1b

The same composition and structure was used, as in example 1a, including the same level of adhesive and wood and moisture. The adhesive contained 100 parts UF resin, 12 parts urea, and 3 parts polyvinylpyrrolidone (K90 from ISP Corporation, on a solids weight basis. (2.6 wt. % PVPy). Preparation of the structure was the same. The tack was 10.2 cm. The addition of 2.6% PVPy gave a 25% increase of tack.

### Example 2

A first component of an adhesive was prepared by making a polyamidoamine-epichlorohydrin resin (PAE resin) at 55% solids according to U.S. patent application Ser. No. 13/020,069 filed Feb. 3, 2011. A second component was made, combining water, Prolia 200/90 soy flour from Cargill, metabisulfite, and glycerol. The water, soy flour and glycerol were mixed with the final ratio being 29 parts water, 20 parts soy flour (dry basis) and 40 parts glycerol (dry basis). The water contained 0.2 parts sodium metabisulfite (1% of the soy flour). 100 parts of this second component (dry weight basis) was combined with 30 parts of the PAE resin (dry weight basis) (76.9% component 2 and 23.1% component 1 on a solids wt. % basis) and enough water to give a final base adhesive formulation of about 53% solids. Wood, in this case the wood meant to be used in the core of a particle board, was treated and pressed into samples in the manner described in example 1. The level of adhesive was 7 parts (dry basis) to 100 wood (dry basis) (93.5% wood, 6.5% adhesive). Identical adhesive formulations were prepared except with the addition of tack additives. These were added at the levels listed in the following table on a wt % basis of the adhesive. The weight of the tack additive is included in the total weight of the adhesive in the examples. The solids of each mixture was adjusted so every sample contained the same moisture and the same total adhesive level (on a solids weight basis).

### Results for Example 2

| | dry wt. % | |
|---|---|---|
| | additive in | |
| Additive | adhesive | Tack (cm) |
| none | none | 5.73 |
| 350,000 MW Polyvinylpyrrolidone | 3.7 | 9.18 |
| (PVP K60 from ISP) | | |
| 60,000 MW Polyvinylpyrrolidone | 3.7 | 6.45 |
| (PVP K30 from ISP) | | |
| <1,000,000 MW Copolymer of | 3.7 | 10.24 |
| vinylpyrrolidone and | | |
| dimethylaminoethylacrylate | | |
| polyacrylic acid | 3.7 | 6.66 |

Each potential tack additive increased tack. Tack was increased by the lower molecular weight polyvinylpyrrolindone (K30) and by polyaerylic acid. A high molecular weight polyvinylpyrrolidone and a high molecular weight copolymer of vinylpyrrolidone and dimethylaminoethylacrylate (obtained from Aldrich) greatly increased tack.

### Example 3

Under identical conditions to example 2 several other potential tack additives were tested. The results are shown in the following table. The maltrodextrin was Maltrin M100 from Grain Processing Corporation. The low molecular weight carboxymethylcellulose (CMC) was Ambergum 3021 from Ashland, the cationic dextran was obtained from Aldrich. The poly(acrylamide/acrylic acid) was Hercobond 2000 from Ashland.

### Results for Example 3

| | dry wt. % of | |
|---|---|---|
| | additive in | |
| Additive | adhesive | Tack (cm) |
| none | none | 6.21 |
| Maltrodextrin | 3.7 | 6.64 |
| Low MW CMC | 3.7 | 7.12 |
| Cationic dextran | 3.7 | 6.38 |
| Poly(acrylamide/acrylic acid) | 3.7 | 9.40 |

The low molecular weight CMC and especially the poly(acrylamide/acrylic acid) were effective for increasing tack.

### Example 4

For this example, 535 g of particleboard wood furnish of the size used for making the core of a particle board was spayed with water and then sprayed with a methylene diphenyl diisocyantate (MDI) from Huntsman called Rubinate 1840, and then sprayed a third time with a 20% solution of polyvinylpyrrolidone (K90 from ISP). The wood was tumbled during spraying with the Bosch Universal PLUS mixer described above. The amount of water sprayed and PVPy solution sprayed are listed in the table below. The amount of MDI sprayed was 15.8 g for each sample. The spraying was onto the wood as the wood was being mixed in a Bosch Universal Mixer as described above.

The tack of the cold pressed wood was measured as previously described. The results are in the following table.

### Results for Example 4

| Water Sprayed | PVPyr sol'n Sprayed | Tack (cm) |
|---|---|---|
| 46 g | 0 g | 2.69 |
| 39.5 g | 7.9 g | 3.17 |
| 25.5 g | 26.3 g | 3.25 |
| 15 g | 39.5 g | 3.38 |

The application of polyvinylpyrrolidone increased the tack of the MDI containing pressed boards.

### Example 5

Conditions similar to example 2 were used again for evaluating tack. The moisture level of all the final treated wood samples was 9.0%. The solids of each adhesive formulation was adjusted to obtain equal moisture in the final samples. The total level of adhesive added was 7 parts (dry basis) to 100 parts wood (dry basis). The parts of the additives used are listed in the table below based on 100 parts of the soy flour mixture (component 2 of example 2, dry basis). The low molecular weight CMC was Ambergum 1221 from Ashland. The polyvinylpyrrolidone was K90 from ISP. The poly(acrylamide/acrylic acid) was Hercobond 2000 from Ashland.

### Results for Example 5

| | dry wt. % of | |
|---|---|---|
| | additive in | |
| Additive | adhesive | Tack (cm) |
| None | none | 6.27 |
| Poly(acrylamide/acrylic acid) | 2.3 | 7.61 |
| low MW CMC | 3.7 | 7.54 |
| 1,000,000 MW poly(vinylpyrrolidone) | 0.8 | 7.22 |

Even at a level of 0.8% the polyvinylpyrrolidone improved the tack. The poly(acrylamide/acrylic acid was effective at 2.3%, and the low molecular weight CMC at 3.7%.

### Example 6

Under the same conditions as example 5, except with 7 pph adhesive, two more polymers were tested. The results are in the following table.

### Results for Example 6

| | dry wt. % of | |
|---|---|---|
| | additive in | |
| Additive | adhesive | Tack (cm) |
| None | none | 6.78 |
| 8000 MW polyethyleneglycol | 2.3 | 7.38 |
| Polyvinylalcohol (Airvol 107 from Air | 2.3 | 6.54 |
| Products) | | |

An 8000 molecular weight polyethylene glycol was added at 2.3% and it slightly decreased tack. It did not meet the viscosity criteria of a polymer tack additive because its viscosity as a 5% solution was below 20 cps. A polyvinyl alcohol (Airvol 107 from Air Products) was added at 2.3% did not statistically improve tack. It also did not have a 5% solids solution viscosity greater than 20 cps.

1. A composition comprising an adhesive and a tack additive, wherein the tack additive is a water soluble polymer with a number average molecular weight greater than 8000 g/mole and a viscosity at 5% solids in water at 22° C. of less than 10,000 cps and greater than 20 cps and a viscosity at 10% solids at 22° C. of less than 50,000 cps and greater than 30 cps.

2. The composition of claim 1 wherein the adhesive is soluble in or can be diluted with water.

3. The composition of claim 1 wherein the adhesive is selected from the group consisting of urea formaldehyde resin, melamine formaldehyde resin, phenol formaldehyde resin, a melamine urea formaldehyde resin or mixtures thereof.

4. The composition of claim 1 wherein the adhesive is an isocyanate.

5. The composition of claim 1 wherein the adhesive is based on a protein source where the source is at least 40% by weight protein.

6. The composition of claim 5 wherein the adhesive comprises a mixture of a protein source and a crosslinker, where the crosslinker is selected from a group consisting of polyamidoamine-epichlorohydrin resins, polyamine-epichlorohydrin resins, an isocyante, an epoxy, and aldehyde, an aldehyde starch, and mixtures thereof.

7. The composition of claim 5 where the protein source is selected from the group consisting of soy flour, soy concentrate, and soy isolate.

8. The composition of claim 1 wherein the amount of the tack additive is less than 20% of the adhesive solids by weight.

9. The composition of claim 1 wherein the tack additive has a molecular weight greater than 100,000 g/mole.

10. The composition of claim 1 wherein the tack additive has a molecular weight greater than 500,000 g/mole.

11. The composition of claim 1 wherein the tack additive comprises a polymer wherein the polymer is selected from the group consisting of carboxymethylcellulose polymer, a polymer formed at least in part from acrylamide, and a polymer formed at least in part from vinylpyrrolidone,

12. The composition of claim 1 wherein the adhesive is based on one or more of the following materials: melamine formaldehyde resin, or a protein.

13. The composition of claim 1 wherein the adhesive comprises soy flour.

14. The composition of claim 1 wherein the tack additive further comprising either a salt or a polar compound that disrupts the intra and or inter polymer chain hydrogen bonding of the tack additive, wherein the amount of salt is less than 50% by weight and the amount of polar compound is less than 100% of the amount of the tack additive polymer.

15. A composite comprising the composition of claim 1 and a lignocellulosic material.

16. The composition of claim 15 where the lignocellulosic material is the primary material of the composite and wherein the lignocellulosic material comprises at least 40% and less than 99% of the solids portion of the composition by volume.

17. The composition of claim 15 where the lignocellulosic is wood.
